(19) United States
(12) Patent Application Publication
(10) Pub. No.: US 2023/0203832 A1
(43) Pub. Date: Jun. 29, 2023

(54) RETRACTABLE AWNING AND ROOM COMBINATION

(71) Applicant: Carefree/Scott Fetzer Company, Broomfield, CO (US)

(72) Inventor: Scott P. Thompson, Aspen, CO (US)

(21) Appl. No.: 17/923,338

(22) PCT Filed: May 17, 2021
(86) PCT No.: PCT/US2021/032723

§ 371 Date: Nov. 4, 2022

Related U.S. Application Data
(60) Provisional application No. 63/025,409, filed on May 15, 2020.

(51) Int. Cl. E04H 15/08; E04H 15/48

(52) U.S. Cl. CPC E04H 15/08; E04H 15/48

(57) ABSTRACT

An awning is provided that extends from an awning casing. The awning forms an arcuate shape by a plurality of panels having a central longitudinal pivot rod for the rotation of at least one lateral support.

### CROSS REFERENCES TO RELATED APPLICATIONS

The following application claims priority under 35 U.S.C. § 119(e) to copending U.S. Provisional Pat. Application Serial No. 63/025,409 filed May 15, 2020 entitled RETRACTABLE AWNING AND ROOM COMBINATION. The above-identified application is incorporated herein by reference in its entirety for all purposes.

### TECHNICAL FIELD

The present disclosure relates to a retractable awning and room combination, and more particularly, an awning that is mounted to a structure that unfurls and expands to provide shelter along the structure.

### BACKGROUND

Awning canopies and their operation have been the subject matter of several U.S. Pat. and U.S. Pat. Publications, all of which are incorporated herein by reference in their entireties for all purposes. Particularly, U.S. Pat. Publication Nos: U.S. 2017/0321427; 2017/0275885 and U.S. Pat. No: 10,316,522 are incorporated herein by reference in their entirety for all purposes.

### SUMMARY

One example embodiment, the present disclosure includes an awning extending from an awning casing, the awning forming an arcuate shape by a canopy defining a plurality of panels.

Another example embodiment, the present disclosure includes an awning extending from an awning casing, the awning forming an arcuate shape by a plurality of panels, having a central longitudinal pivot rod for the rotation of at least one lateral support.

While yet another example embodiment, the present disclosure includes an awning contained during storage entirely within an awning casing, the awning forming an arcuate shape in an extended position by a plurality of panels, two panels forming an upper panel section and two panels forming a lower panel section. Coupling the upper section with the lower section is a central longitudinal pivot rod. The upper panel section comprising an upper longitudinal sliding rod and the lower panel section comprising a lower longitudinal sliding rod. The central longitudinal pivot rod is spaced from said longitudinal sliding rods by a plurality of lateral supports that both translate and rotate about said upper and lower longitudinal sliding rods when extending and collapsing said awning.

In a further example embodiment, the present disclosure includes an awning contained during storage entirely within an awning casing, the awning forming an arcuate shape in an extended position by a plurality of panels, two panels forming an upper panel section and two panels forming a lower panel section. Coupling the upper section with the lower section is a central longitudinal pivot rod. The upper panel section comprises an upper longitudinal sliding rod and the lower panel section comprises a lower longitudinal sliding rod. The central longitudinal pivot rod is spaced from said longitudinal sliding rods by a plurality of lateral supports that both translate and rotate about said upper and lower longitudinal sliding rods when extending and collapsing said awning. The lateral supports comprise a pivotal connection with the central longitudinal pivot rod. The central longitudinal pivot rod providing any combination of power, lighting, speaker sound, fans, insect repellant, and/or movie screen to a room formed by the arcuate shape of the awning.

While in a further example embodiment, the present disclosure includes an awning contained during storage entirely within an awning casing, the awning forming an arcuate shape in an extended position by a plurality of panels, two panels forming an upper panel section and two panels forming a lower panel section. Coupling the upper section with the lower section is a central longitudinal pivot rod. The upper panel section comprises an upper longitudinal sliding rod and the lower panel section comprises a lower longitudinal sliding rod. The central longitudinal pivot rod is spaced from said longitudinal sliding rods by a plurality of lateral supports that both translate and rotate about said upper and lower longitudinal sliding rods when extending and collapsing said awning. The lateral supports comprise a pivotal connection with the central longitudinal pivot rod. The arcuate shape formed by the awning forming first and second ends. The awning further comprising a planar side for enclosing at least one of said first and second ends.

In yet a further example embodiment, the present disclosure includes an awning contained during storage entirely within an awning casing, the awning forming an arcuate shape in an extended position by a plurality of panels, two panels forming an upper panel section and two panels forming a lower panel section. Coupling the upper section with the lower section is a central longitudinal pivot rod. The upper panel section comprises an upper longitudinal sliding rod and the lower panel section comprises a lower longitudinal sliding rod. The central longitudinal pivot rod is spaced from said longitudinal sliding rods by a plurality of lateral supports that both translate and rotate about said upper and lower longitudinal sliding rods when extending and collapsing said awning. The lateral supports comprise a pivotal connection with the central longitudinal pivot rod. The awning comprising an upper panel assembly and a lower panel assembly having a longitudinal length greater than the longitudinal length of the awning casing.

Another example embodiment, the present disclosure includes first and second awnings contained during storage entirely within first and second awning casings, the awnings forming an arcuate shape in an extended position by a plurality of panels, two panels forming an upper panel section and two panels forming a lower panel section. Coupling the upper section with the lower section is a central longitudinal pivot rod. The upper panel section comprises an upper longitudinal sliding rod and the lower panel section comprises a lower longitudinal sliding rod. The central longitudinal pivot rod is spaced from said longitudinal sliding rods by a plurality of lateral supports that both translate and rotate about said upper and lower longitudinal sliding rods when extending and collapsing said awnings. The lateral supports comprise a pivotal connection with the central longitudinal pivot rod.

One example embodiment of the present disclosure includes an awning extending from an awning casing. The awning forming an arcuate shape. The awning comprising an awning casing that is couplable to a surface, the awning casing supporting a roll bar coupled to a first end of a canopy, the awning casing and the roll bar extending along a longitudinal axis, the awning casing coupled to a first lateral support. The awning further comprising a first translational and rotational joint coupling the first lateral support and a second lateral support to an upper longitudinal pivot rod, the upper longitudinal pivot rod extending along the longitudinal axis, the first and second lateral supports extending along lateral and horizontal directions when the awning is in an extended position, the translational and rotational joint translating along the longitudinal axis during extension and retraction of the awning along the lateral and horizontal directions. The awning further comprising a rotational joint coupling the second lateral support and a third lateral support to a central longitudinal pivot rod, the central longitudinal pivot rod extending along the longitudinal axis, the second and third lateral supports extending along the lateral and horizontal directions when the awning is in the extended position, the rotational joint rotating during extension and retraction of the awning.

Another example embodiment of the present disclosure includes an awning extending from an awning casing. The awning forming an arcuate shape. The awning comprising an awning casing that is couplable to a surface, the awning casing coupled to a first end of a canopy, the awning casing extending along a longitudinal axis, the awning casing coupled to a first lateral support. The awning further comprising a first translational and rotational joint coupling the first lateral support and a second lateral support to an upper longitudinal pivot rod, the upper longitudinal pivot rod extending along the longitudinal axis, the first and second lateral supports extending along lateral and horizontal directions when the awning is in an extended position, the translational and rotational joint translating along the longitudinal axis during extension and retraction of the awning along the lateral and horizontal directions. The awning additionally comprising a rotational joint coupling the second lateral support and a third lateral support to a central longitudinal pivot rod, the central longitudinal pivot rod extending along the longitudinal axis, the second and third lateral supports extending along the lateral and horizontal directions when the awning is in the extended position, the rotational joint rotating during extension and retraction of the awning. The awning further comprising a second translational and rotational joint coupling the third lateral support and a fourth lateral support to a lower longitudinal pivot rod, the second translational and rotational joint translating along the longitudinal axis during extension and retraction of the awning along the lateral and horizontal directions. Additionally, the awning comprises a lead rail coupled to a second end of the canopy, the lead rail coupled to the fourth lateral support rod, the canopy extending between the awning casing and the lead rail in the extended position, the canopy interacting with the upper, center, and lower longitudinal support rods to form an arced surface, when fully extended the lead rail is extended laterally and horizontally away from the awning casing.

Yet another example embodiment of the present disclosure includes an awning extending from an awning casing. The awning forming an arcuate shape. The awning comprising an awning casing that is couplable to a surface, the awning casing supporting a roll bar coupled to a first end of a canopy, the awning casing and the roll bar extending along a longitudinal axis, the awning casing coupled to a first lateral support. The awning further comprising a first translational and rotational joint coupling the first lateral support to a second lateral support rod via a rotating joint, and coupling the rotating joint to an upper longitudinal pivot rod via a pin and glide, the upper longitudinal pivot rod extending along the longitudinal axis, the upper longitudinal pivot rod defining a track that extends longitudinally along at least a portion of the upper longitudinal pivot rod, the glide movably housed within the track, the first and second lateral supports concurrently extending along lateral and horizontal directions when the awning is in an extended position, the translational and rotational joint translating along the longitudinal axis during extension and retraction of the awning along the lateral and horizontal directions. The awning additionally comprising a rotational joint coupling the second lateral support to a third lateral support via a hinge joint, and the hinge joint coupled to an elbow pin, the elbow pin coupled to a rotating elbow joint housed within a complementary elbow housing, the rotating elbow joint and the complementary elbow housing are housed within an end cap of the central longitudinal pivot rod, the central longitudinal pivot rod extending along the longitudinal axis, the second and third lateral supports extending along the lateral and horizontal directions when the awning is in the extended position, the rotational joint rotating during extension and retraction of the awning. The awning also comprising a second translational and rotational joint coupling the third lateral support to a fourth lateral support via a second rotating joint, and coupling the second rotating joint to a lower longitudinal pivot rod via a second pin and second glide, the lower longitudinal pivot rod extending along the longitudinal axis, the lower longitudinal pivot rod defining a second track that extends longitudinally along at least a portion of the lower longitudinal pivot rod, the second glide movably housed within the second track, the third and fourth lateral supports extending concurrently along the lateral direction and the horizontal direction when the awning is in the extended position, the second translational and rotational joint translating along the longitudinal axis during extension and retraction of the awning along the lateral and horizontal directions. Further, the awning comprising a lead rail coupled to a second end of the canopy, the lead rail coupled to the fourth lateral support rod, the canopy extending between the awning casing and the lead rail in the extended position, the canopy interacting with the upper, center, and lower longitudinal support rods to form an arced surface, when fully extended the lead rail is extended laterally and horizontally away from the awning casing.

Yet another example embodiment of the present disclosure includes a method of utilizing an awning casing that is couplable to a surface, the awning forming an arcuate shape, the method comprising the steps of supplying the awning casing supporting a roll bar coupled to a first end of a canopy, the awning casing and the roll bar extending along a longitudinal axis, coupling the awning casing to a first lateral support, and coupling the first lateral support to a second lateral support and coupling both to an upper longitudinal pivot rod via a first translational and rotational joint, the upper longitudinal pivot rod extending along the longitudinal axis, the first and second lateral supports extending along lateral and horizontal directions when the awning is in an extended position, the translational and rotational joint translating along the longitudinal axis during extension and retraction of the awning along the lateral and horizontal directions. The method further includes coupling the second lateral support to a third lateral support and coupling both to a central longitudinal pivot rod via a rotational joint, the central longitudinal pivot rod extending along the longitudinal axis, the second and third lateral supports extending along the lateral and horizontal directions when the awning is in the extended position, the rotational joint rotating during extension and retraction of the awning, coupling the third lateral support to a fourth lateral support and coupling both to a lower longitudinal pivot rod via a second translational and rotational joint, the second translational and rotational joint translating along the longitudinal axis during extension and retraction of the awning along the lateral and horizontal directions, and coupling a lead rail to a second end of the canopy, and coupling the lead rail to the fourth lateral support rod, the canopy extending between the awning casing and the lead rail in the extended position, the canopy interacting with the upper, center, and lower longitudinal support rods to form an arced surface, when fully extended the lead rail is extended laterally and horizontally away from the awning casing.

Yet another example embodiment of the present disclosure includes an awning extending from a surface, the awning forming an arcuate shape, the awning comprising a canopy that is couplable to a surface, the canopy extending over upper and central longitudinal support rods when the awning is in an extended position, and a first translational and rotational joint coupling a first lateral support and a second lateral support to the upper longitudinal pivot rod, the upper longitudinal pivot rod extending along the longitudinal axis, the first and second lateral supports extending along lateral and horizontal directions when the awning is in an extended position, the translational and rotational joint translating along the longitudinal axis during extension and retraction of the awning along the lateral and horizontal directions. The awning further comprising a rotational joint coupling the second lateral support and a third lateral support to the central longitudinal pivot rod, the central longitudinal pivot rod extending along the longitudinal axis, the second and third lateral supports extending along the lateral and horizontal directions when the awning is in the extended position, the rotational joint rotating during extension and retraction of the awning.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1A is an upper-right perspective view illustrating a retractable awning and room combination in an extended condition in accordance with a first embodiment of the present disclosure;

FIG. 1B is an upper-right perspective view illustrating a retractable awning and room combination in a collapsed condition in accordance with the first embodiment of the present disclosure;

FIG. 2 is an upper-left perspective view of FIG. 1A;

FIG. 3 is a first lower-right perspective view of FIG. 1A;

FIG. 4 is a second lower-right perspective view of FIG. 1A;

FIG. 4A is partial view of FIG. 4, including a magnified portion of a translational and rotational joint;

4A1 is a partial view of FIG. 4 in a retracted position wherein elements are omitted for clarity;

FIG. 4A2 is a view of FIG. 4A1 taken along section line 4A2-4A2;

FIG. 4B is a view of FIG. 4A taken along section line 4B-4B;

FIG. 4C is a view of FIG. 4A taken along section line 4C-4C;

FIG. 4D is partial view of FIG. 4, including a magnified portion of a rotational joint;

FIG. 4D1 is a partial view of FIG. 4 in a retracted position wherein elements are omitted for clarity;

FIG. 4D2 is a view of FIG. 4D1 taken along section line 4D2-4D2;

FIG. 4E is partial right side view of FIG. 4, including a magnified portion of a rotational joint;

FIG. 4F is magnified view of a rotational joint where portions of an awning pivot rod are shown in phantom;

FIG. 5 is a rear elevation view of FIG. 1A;

FIG. 6 is a front elevation view of FIG. 1A;

FIG. 7 is a top plan view of FIG. 1A;

FIG. 8 is a bottom plan view of FIG. 1A;

FIG. 9 is a right-side elevation view of FIG. 1A;

FIG. 9A is a view of FIG. 9 in a partially extended position, in accordance with one embodiment of the present disclosure;

FIG. 9B is a view of FIG. 9 in a partially extended position, in accordance with one embodiment of the present disclosure;

FIG. 9C is a view of rod ends rotating between an extended position to a retracted position.

FIG. 10 is a left-side elevation view of FIG. 1A;

FIG. 11A is an upper-right perspective view illustrating a retractable awning and room combination in an extended condition in accordance with a second embodiment of the present disclosure;

FIG. 11B is an upper-right perspective view illustrating a retractable awning and room combination in a collapsed condition in accordance with the second embodiment of the present disclosure;

FIG. 12 is an upper-left perspective view of FIG. 11A;

FIG. 13 is a lower-left perspective view of FIG. 11A;

FIG. 14 is a lower-right perspective view of FIG. 11A;

FIG. 15 is a rear elevation view of FIG. 11A;

FIG. 16 is a front elevation view of FIG. 11A;

FIG. 17 is a top plan view of FIG. 11A;

FIG. 18 is a bottom plan view of FIG. 11A;

FIG. 19 is a right-side elevation view of FIG. 11A;

FIG. 20 is a left-side elevation view of FIG. 11A;

FIG. 21A is an upper-right perspective view illustrating a retractable awning and room combination in an extended condition in accordance with a third embodiment of the present disclosure;

FIG. 21B is an upper-right perspective view illustrating a retractable awning and room combination in a collapsed condition in accordance with the third embodiment of the present disclosure;

FIG. 22 is an upper-left perspective view of FIG. 21A;

FIG. 23 is a lower-right perspective view of FIG. 21A;

FIG. 24 is a lower-left perspective view of FIG. 21A;

FIG. 25 is a rear elevation view of FIG. 21A;

FIG. 26 is a front elevation view of FIG. 21A;

FIG. 27 is a top plan view of FIG. 21A;

FIG. 28 is a bottom plan view of FIG. 21A;

FIG. 29 is a right-side elevation view of FIG. 21A;

FIG. 30 is a left-side elevation view of FIG. 21A;

FIG. 31A is an upper-right perspective view illustrating a retractable awning and room combination in an extended condition in accordance with a fourth embodiment of the present disclosure;

FIG. 31B is an upper-right perspective view illustrating a retractable awnings and room combinations in a collapsed condition in accordance with the fourth embodiment of the present disclosure;

FIG. 32 is an upper-left perspective view of FIG. 31A;

FIG. 33 is a first lower-left perspective view of FIG. 31A;

FIG. 34 is a second lower-left perspective view of FIG. 31A;

FIG. 35 is a front elevation view of FIG. 31A;

FIG. 36 is a rear elevation view of FIG. 31A;

FIG. 37 is a top plan view of FIG. 31A;

FIG. 38 is a bottom plan view of FIG. 31A;

FIG. 39 is a right-side elevation view of FIG. 31A; and

FIG. 40 is a left-side elevation view of FIG. 31A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to a retractable awning and room combination, and more particularly, an awning that is mounted to a structure that unfurls and expands to provide shelter along the structure.

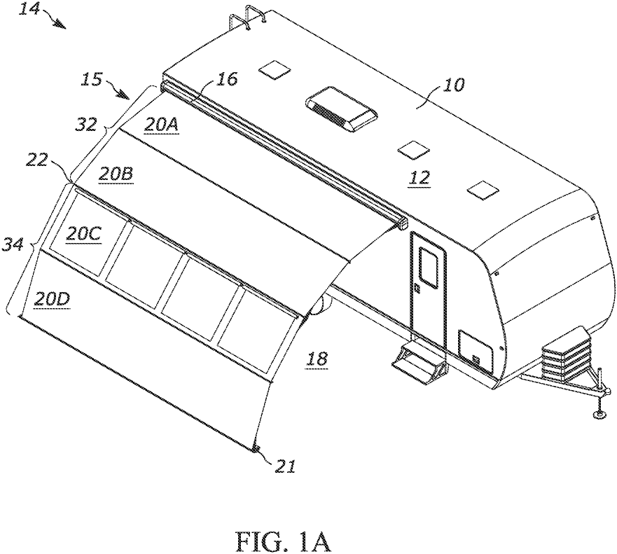

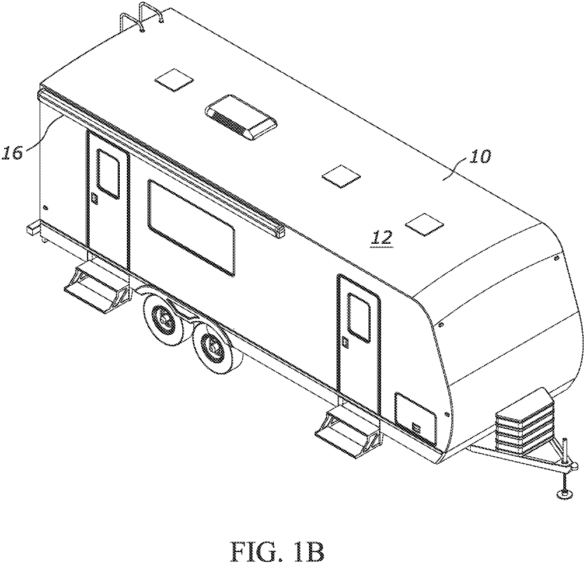

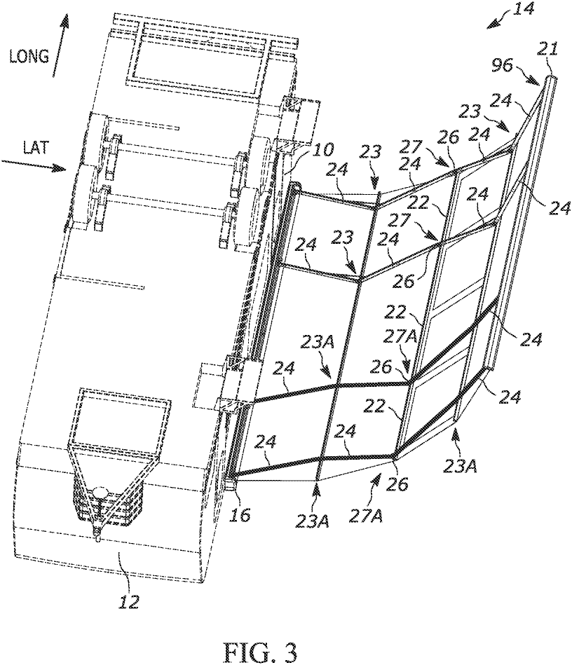

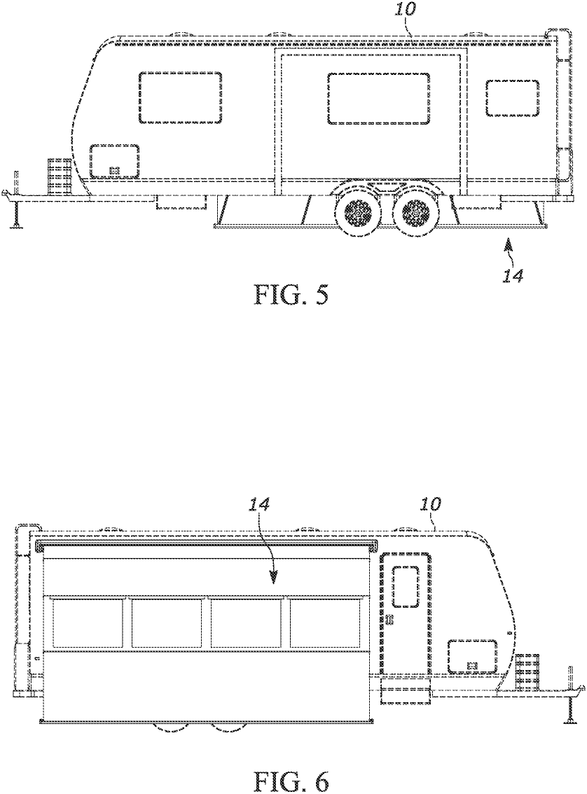

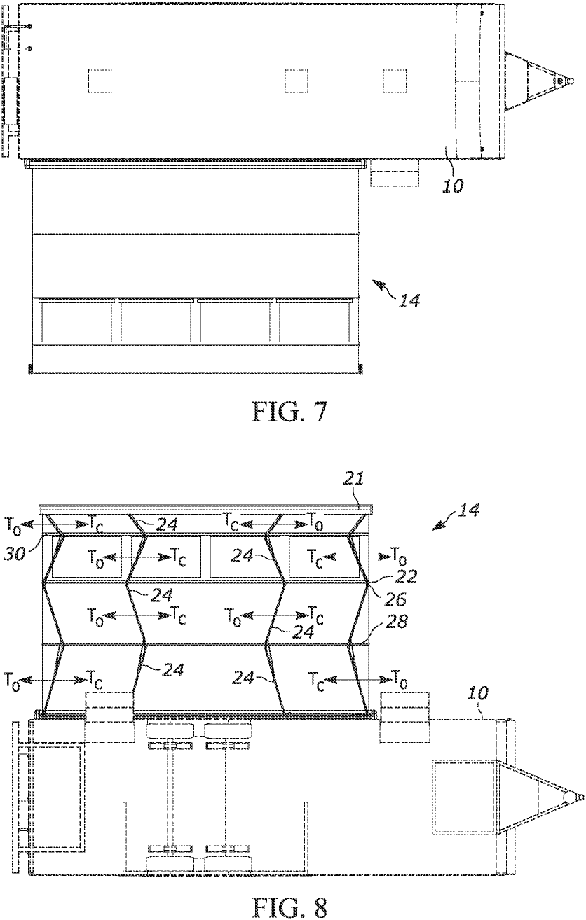

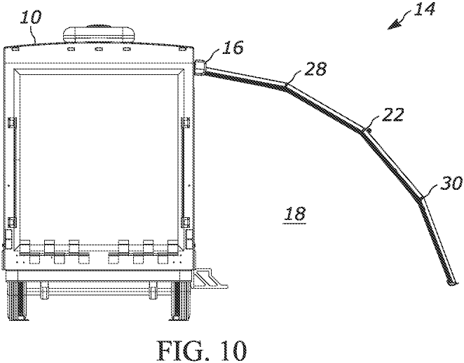

FIGS. 1A and 2-11 illustrate a retractable awning 14 and room combination in an extended condition from a structure 10 in accordance with a first embodiment of the present disclosure. In the illustrated example embodiment, the structure 10 is a camper 12, but could equally be a motorhome, building, or house without departing from the spirit and scope of the claimed disclosure. FIG. 1B illustrates the retractable awning 14 and room combination in a collapsed or closed position all the structures being located within an awning casing 16.

One example embodiment, the present disclosure includes a retractable awning 14 extending from the awning casing 16, the awning forming an arcuate shaped room 18 defined by a plurality of panels 20. In one example embodiment, a canopy 15 makes up the plurality of panels 20. The awning 14 includes an lead bar 21, that can extend to the ground or be elevated from the ground. In one example embodiment, the lead bar 21 secures the awning 14 from wind etc. by providing stake attachments, frequently used by tents and canopies.

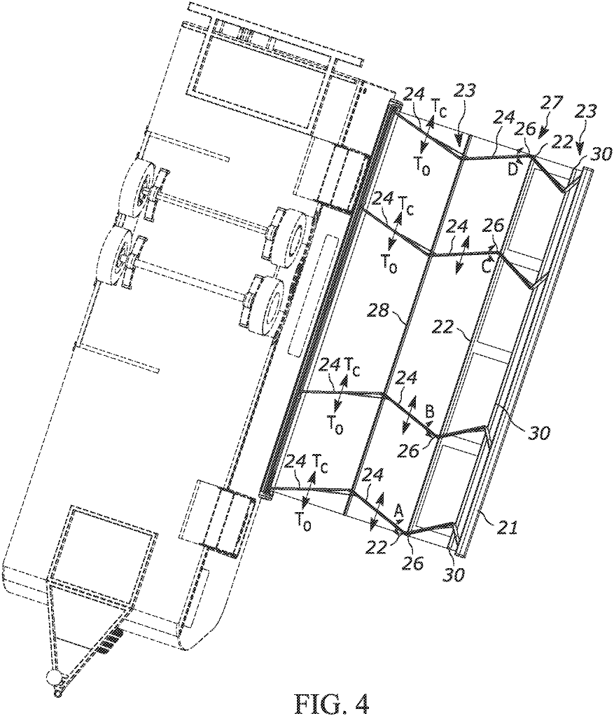

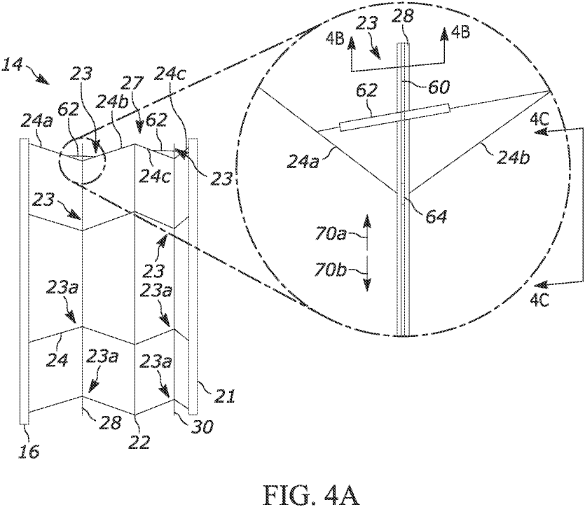

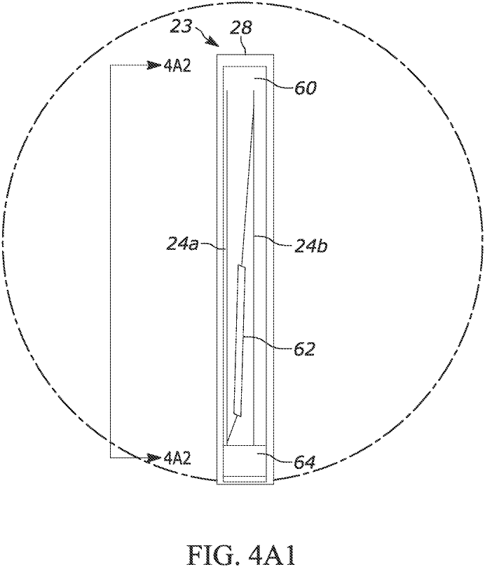

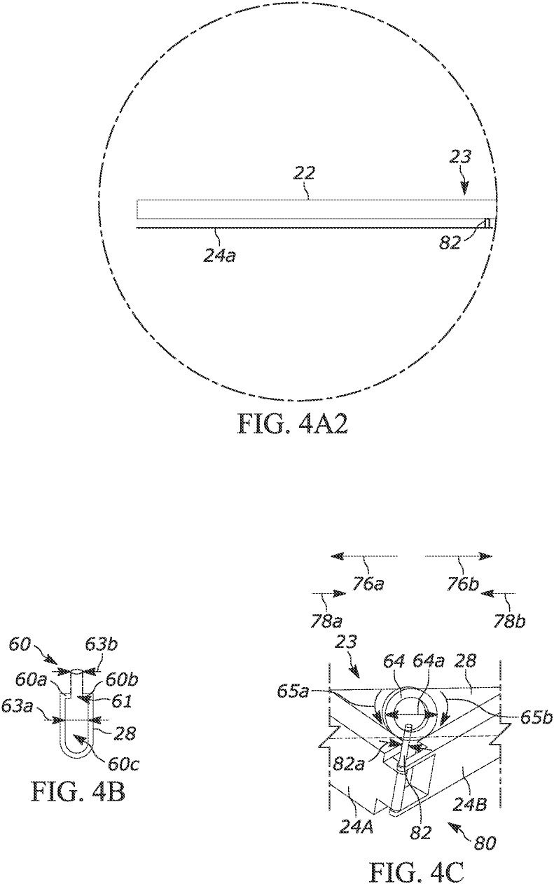

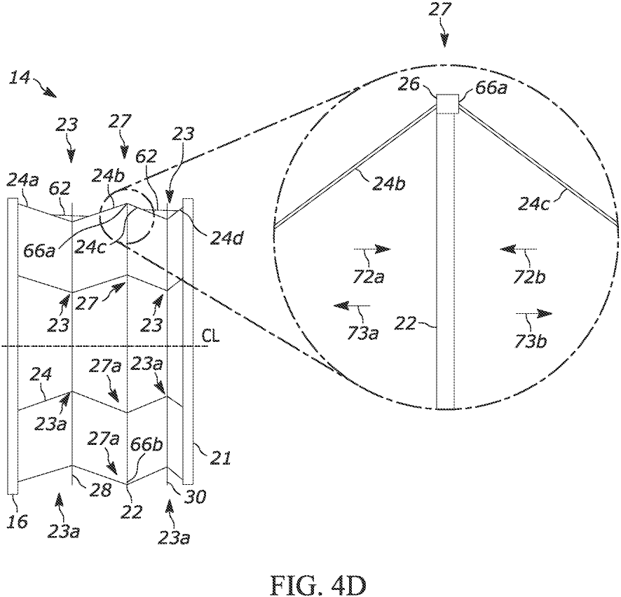

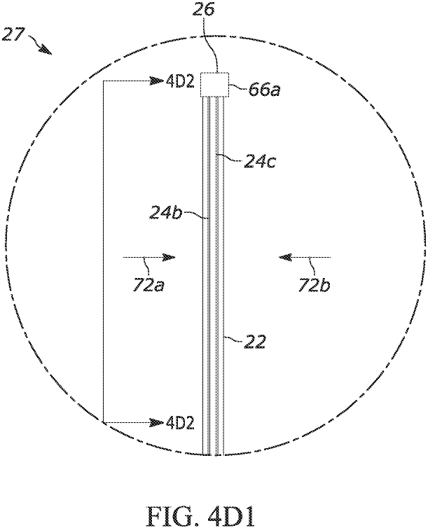

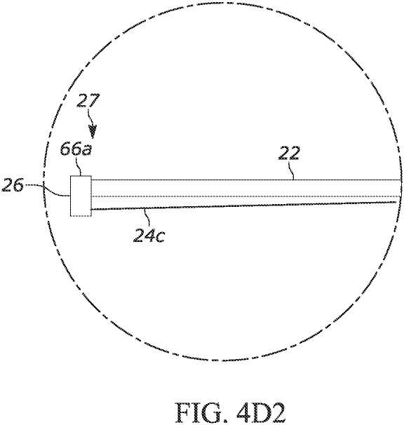

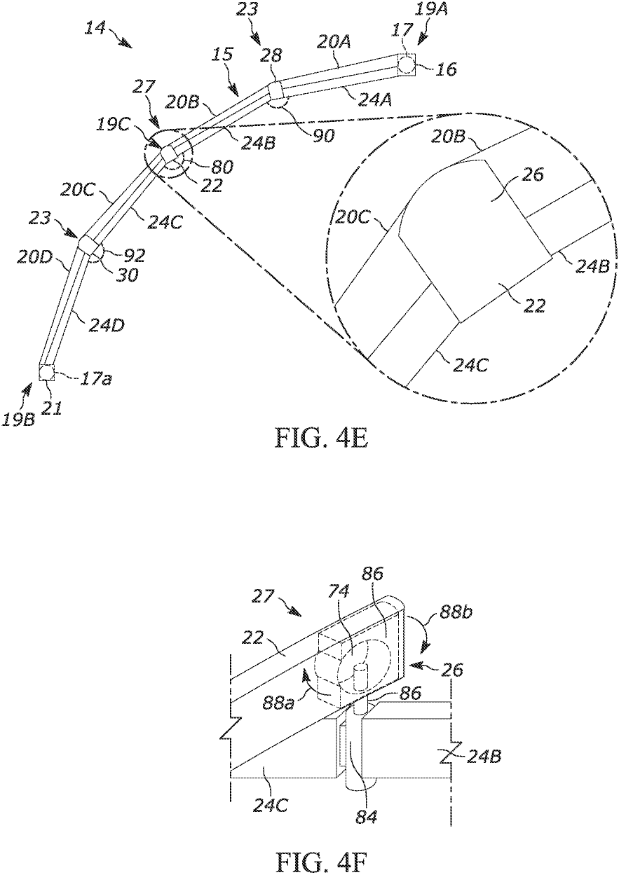

Another example embodiment, the present disclosure includes an awning 14 extending from the awning casing 16. The awning 14 forms the arcuate shape 18 defined by the plurality of panels 20. The awning 14 has a central longitudinal pivot rod 22 for the rotation of at least one lateral support 24 about respective pivot points 26 as indicated by arrows A, B, C, and D in FIG. 4. As the awning 14 opens, the lateral supports translate about longitudinal sliding rods 28 and 30 in the direction of arrows Tₒ, pivoting on the longitudinal pivot rod 22 at respective pivot points 26. As the awning 14 closes, the lateral supports 24 translate about longitudinal sliding rods 28 and 30 in the direction of arrows T_{c}, pivoting on the longitudinal pivot rod 22 at respective pivot points 26. In one example embodiment, the longitudinal sliding rods 28, 30 and the longitudinal pivot rod 22 define a rectangular, square, and/or circular shape, are t-shaped, I-shaped, pentagonal, hexagonal, or the like. In another example embodiment, the longitudinal sliding rods 28, 30 and the longitudinal pivot rod 22 define a rectangular bottom and a rounded top. In this example embodiment, the orientation of the longitudinal sliding rods 28, 30 and the longitudinal pivot rod 22 change as the awning 14 is extended such that the rounded top remains facing away from the structure 10, and/or in contact with the canopy 15. In one example embodiment, the lateral supports 24 define a rectangular, square, and/or circular shape, are t-shaped, I-shaped, pentagonal, hexagonal, or the like.

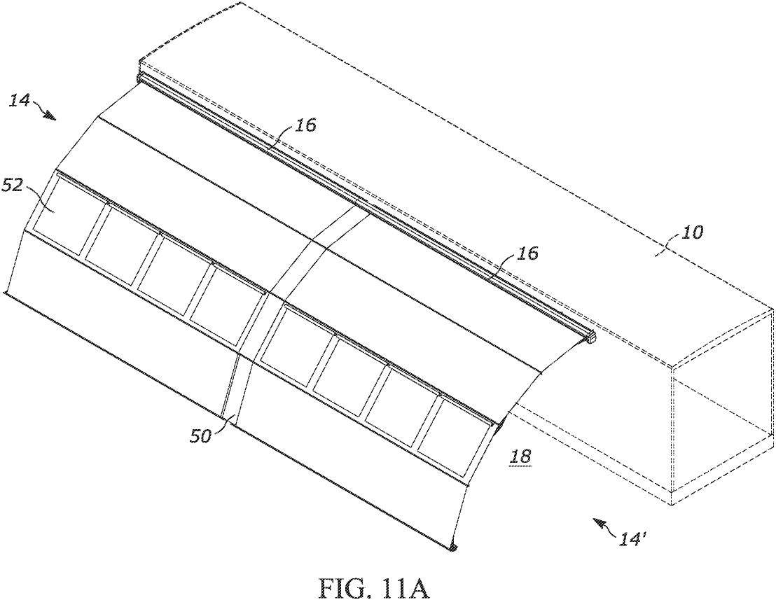

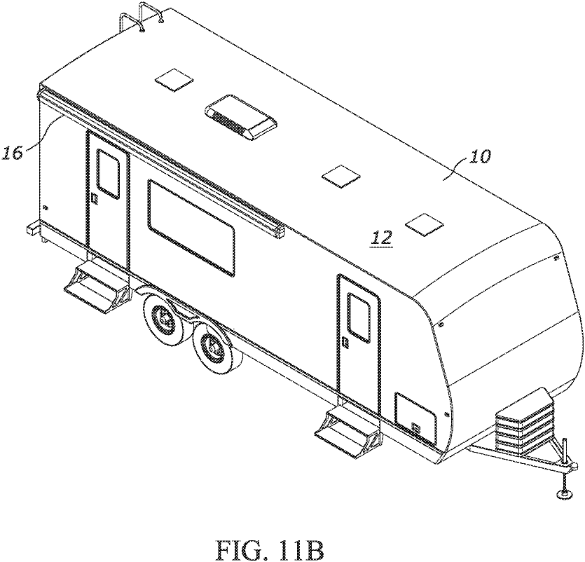

In one example embodiment, the panels 20 and/or the canopy 15 are formed from a textile and/or fabric. In another example embodiment, the panels 20 and/or the canopy 15 are formed from a canvas, vinyl, polymeric material, or any combination thereof. In another example embodiment, the longitudinal sliding rods 28, 30, the longitudinal pivot rod 22, and the lateral supports 24 are made from fiberglass, plastic, metal, composite, or any combination thereof. In another example embodiment, the longitudinal sliding rods 28, 30, the longitudinal pivot rod 22, and the lateral supports 24 are formed by molding, injection molding, extruding, roll forming, break forming, welding, and/or the like. In yet another example embodiment, the longitudinal sliding rods 28, 30, the longitudinal pivot rod 22, and the lateral supports 24 are made from aluminum extrusions having a different die profile. In one example embodiment, the panels 20 and/or the canopy 15 include windows 52 (see FIG. 11A).

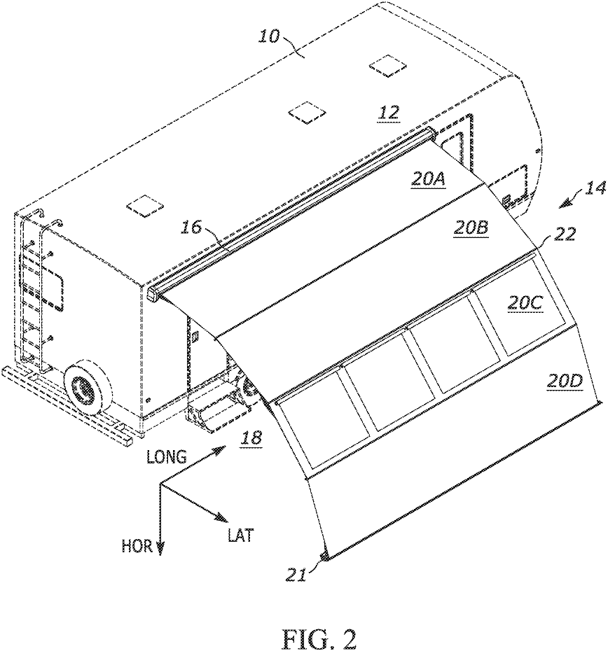

While yet another example embodiment, the present disclosure includes an awning 14 contained during storage entirely within the awning casing 16. The awning 14 forming an arcuate shape 18 in an extended position by a plurality of panels 20, two panels 20A and 20B forming an upper panel section 32 and two panels 20C and 20D forming a lower panel section 34, as illustrated in FIG. 1A. Coupling the upper section 32 with the lower section 34 is a central longitudinal pivot rod 22. The upper panel section 32 comprising an upper longitudinal sliding 28 rod and the lower panel section comprising a lower longitudinal sliding rod 30. The central longitudinal pivot rod 22 is spaced from said longitudinal sliding rods 28, 30 by a plurality of lateral supports 24 that both translate and rotate about said upper and lower longitudinal sliding rods when extending and collapsing said awning. As illustrated in FIG. 2, the longitudinal rods 22, 28, 30 extend along a longitudinal axis LONG. The awning 14, as it extends, extends along both a lateral direction LAT and a horizontal direction HOR, creating the arcuate surface of the awning 14.

In a further example embodiment, the present disclosure includes an awning 14 contained during storage entirely within an awning casing 16. In this example embodiment, the awning casing 16 houses a roll bar 17 (shown in dashed lines in FIG. 4E) attached to a first end 19a of the panels 20. In an alternate example embodiment, the lead bar 21 houses a roll bar 17a. In that example embodiment, the first end 19a of the panels 20/canopy 15 is attached to the awning casing 16, and a second end 19b of the panels 20/canopy 15 is attached to the roll bar 17a housed within the lead bar 21. In one embodiment, the canopy 15, comprising the panels 20, is attached the roll bar 17 at a first end 19a of the canopy and to the lead bar 21 at a second end 19b of the canopy. In this example embodiment, the canopy 15 is unrolled from the roll bar 17 during extension of the awning 14, and is rolled onto the roll bar during retraction. In this example embodiment, the canopy 15 is a unitary canopy that makes up the panels 20. The canopy 15 slides over elements 22, 28, and 30 during extension and retraction, wherein tension is maintained by tension members in the roll bar 17.

The awning 14 forms an arcuate shape 18 in an extended position by a plurality of panels 20, two panels 20A and 20B forming an upper panel section 32 and two panels 20C and 20D forming a lower panel section 34. Coupling the upper section 32 with the lower section 34 is a central longitudinal pivot rod 22. In one example embodiment, the canopy 15 is coupled to the central longitudinal pivot rod 22. In another example embodiment, the first end 19a of the canopy 15 is coupled to the roll bar 19, and a mid-point 17c of the canopy is coupled to the central longitudinal pivot rod 22, and the second end 17b is coupled to the lead rail 21. The upper panel section 32 comprises the upper longitudinal sliding rod 28 and the lower panel section comprises the lower longitudinal sliding rod 30.

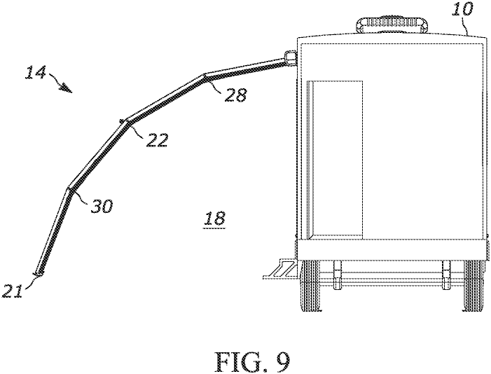

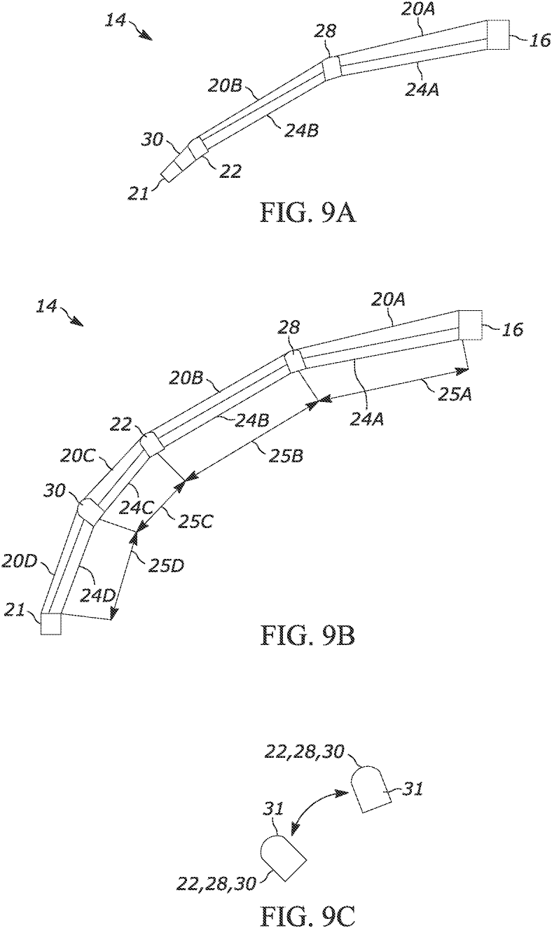

As illustrated in FIGS. 9, 9A-9B, the awning 14 is partially and fully extendable, wherein the lead rail 21 may be extended to the ground, or partially extended to create a partial enclosed space. In the example embodiment of FIG. 9A, the awning 14 is extended halfway. In this embodiment, first and second supports 24a, 24b of the plurality of lateral supports 24 are fully extended while third and fourth supports 24c, 24d of the plurality of lateral supports 24 are fully retracted. As illustrated in the example embodiment of FIG. 9B, the awning 14 is about ¾ extended. In this example embodiment, extension distances 25a, 25b that the first and second supports 24a, 24b are extended, respectively, are substantially equal, while partial extension distances 25c, 25d that the third and fourth supports 24c, 24d are extended, respectively, are substantially equal. Further in this extension, the partial extension distances 25c, 25d are substantially half of the extension distances 25a, 25b. Stated another way, in this example embodiment, the upper panel section 32 is fully extended prior to the extension of the lower panel section 34. As illustrated in FIG. 9C, the pivot rods 22, 28, 30 rotate during extension and retraction. In one example embodiment, such as when a front face 31 of the pivot rods 22, 28, 30 defines an arced surface, the pivot rods 22, 28, 30 rotate such that the front face remains in contract with the canopy 15.

The central longitudinal pivot rod 22 is spaced from said longitudinal sliding rods by the plurality of lateral supports 24 that both translate and rotate about said upper and lower longitudinal sliding rods 28, 30 when extending and collapsing said awning 14. As illustrated in the example embodiments of FIGS. 4A-4C, one or more first translational and rotational joints 23 of the longitudinal rod 28 is illustrated. In this embodiment, a first lateral support 24a of the plurality of lateral supports 24 couples the awning casing 16 to the upper longitudinal rod 28, and a second lateral support 24b of the plurality of lateral supports 24 couples the upper longitudinal rod 28 to the central longitudinal pivot rod 22. In one example embodiment, the first lateral support 24a is coupled to the awning casing 16 by a rail joint 96. The rail joint 96 comprising a hinge or elbow joint. The first and second lateral supports 24a, 24b are coupled to a gas springs 62, or another tension component. In this example embodiment, the awning retracts or extends in cooperation with gas springs 62.

As illustrated in the example embodiment of FIG. 4C, the first and second lateral supports 24a, 24b are coupled together by a rotating joint 80 of the first translational and rotational joint 23. In one example embodiment, the rotating joint 80 is an elbow pivot and clevis. In one example embodiment, the rotation joint 80 includes a pin 82 that extends through the first and second lateral supports 24a, 24b, rotationally coupling the first and second lateral supports 24a, 24b, such that the first and second lateral supports 24a, 24b pivot toward each other when moved along the direction indicated by arrows 78a, 78b, and away from each other when moved along the direction indicated by arrows 76a, 76b. In this example embodiment, the rotation joint 80 maintains the first and second lateral supports 24a, 24b in a constant orientation, wherein in the retracted position, the first and second lateral supports 24a, 24 reside in a common plane, as illustrated in FIG. 4A1-4A2. Stated another way, the rotation joint 80 maintains the first and second lateral supports 24a, 24b such that the first and second lateral supports 24a, 24b are mirror images of each other during pivoting toward 78a, 78b and pivoting away 76a, 76b from each other. In this example embodiment, the first and second lateral supports 24a, 24b are parallel to each other, while the pin 82 of the rotation joint 80 is between 10° to about 15° away from being perpendicular to the first and second lateral supports 24a, 24b. In one example embodiment, such as illustrated in FIG. 4A1-4A2, the first and second lateral supports 24a, 24b pivot about the rotation joint 80 in toward each other along the direction indicated by arrows 78a, 78b until the first and second lateral supports 24a, 24 are substantially parallel to each other, such as when residing within the awning casing 16. In another example embodiment, responsive to the awning 14 being fully retracted, the first and second lateral supports 24a, 24b being substantially parallel to one another, reside at least partially in line with or under the upper longitudinal pivot rod 22. In this example embodiment, the gas spring 62 resides between the first and second lateral supports 24a, 24b and directly beneath or in line with the upper longitudinal pivot rod 22. In another example embodiment, the first and second lateral supports 24a, 24b have slots or depressions in which the gas spring 62 resides when the first and second lateral supports 24a, 24b are substantially parallel to each other, and/or in contact with each other, such as when the awning 14 is fully retracted.

As illustrated in FIGS. 4A-4C, the first translational and rotational joint 23 includes a glide 64 coupled to the rotating joint 80. In one example embodiment, the pin 82 of the rotating joint 80 extends into and is rotationally coupled to the glide 64. Stated another way, the pin 82 rotates as shown by arrows 65a, 65b about the pin independently of the position of the glide 64. The glide 64 defines a circular, oval, polygonal, rectangular or other shape. The glide 64 resides in a track 60 defined within the upper longitudinal rod 28. In the illustrated example embodiment of FIG. 4B, the track 60 is substantially u-shaped and defines a central cavity 60c, and first and second retaining flanges 60a, 60b, although other shapes are contemplated. In this example embodiment, the glide 64 resides in the central cavity 60c, and the pin 82 extends between the first and second retaining flanges 60a, 60b. A central width 63a of the central cavity 60c is greater than a retaining width 63b separating inward faces of the first and second retaining flanges 60a, 60b. Additionally, a glide width or diameter 64a of the glide 64 is larger than a pin width or diameter 82a of the pin 82. In one example embodiment, the glide width or diameter 64a is between 1 mm to about 1 cm less than the central width 63a, and the pin width or diameter 82a is between 1 mm to about 1 cm less than retaining width 63b. The channel 60 and the glide 64 comprise complementary shapes, such that the glide 64 shape residing within the central cavity 60c complements the central cavity shape. The glide 64 moves along direction 70b when the awning 14 is retracting, and along direction 70a when the awning is extending. Stated another way, the glide 64 moves toward a central line CL (see FIG. 4D) of the awning 14 when the awning is being retracted and away from the center line CL when the awning is being extended. In this example embodiment, the first and second lateral supports 24a, 24b move away from each other along arrows 76a, 76b when the glide 64 moves along direction 70a, and move toward each other along arrows 78a, 78b when the glide moves along direction 70b. In this example embodiment, the first and second lateral supports 24a, 24b are extended relative to each other at an upper angle 90 when in the extended position. In one example embodiment, the upper angle 90 is between 130° and 170°. In one example embodiment, the upper angle 90 gets progressively larger until the awning 14 is in the retracted position (e.g., until the first and second lateral supports 24a, 24b are parallel to each other).

As illustrated in the example embodiments of FIGS. 4A-4C, one or more mirrored first translational and rotational joints 23a of the upper longitudinal rod 28 are substantially the same as the first translational and rotational joints 23 of the upper longitudinal rod 28, except that the mirrored first translational and rotational joints 23a are mirror images of the first translational and rotational joints 23 and move in mirror image motions during extension and retraction of the awning 14. In this example embodiment, first and second lateral supports 24a, 24b coupled to one or more mirrored first translational and rotational joints 23a move away from each other along arrows 76a, 76b when the glide 64 moves along direction 70b, and move toward each other along arrows 78a, 78b when the glide moves along direction 70a.

As illustrated in the example embodiments of FIGS. 4A-4C, one or more second translational and rotational joints 23 of the lower longitudinal rod 30 are substantially the same as the first translational and rotational joints 23 of the longitudinal rod 28, except that the second translational and rotational joint 23 of the lower longitudinal rod 30 couples a third lateral support 24c of the plurality of lateral supports 24 to a fourth lateral support 24d of the plurality of lateral supports 24, wherein the third lateral support couples the lower longitudinal rod 30 to the central longitudinal pivot rod 22 and the fourth lateral support couples the lower longitudinal rod 30 to the lead rail 21 (e.g., via a hinge or other joint). In this example embodiment, the third and fourth lateral supports 24c, 24d are extended relative to each other at a lower angle 92 when the awning 14 is in the extended position. In one example embodiment, the lower angle 92 is between 130° and 170°. In one example embodiment, the lower angle 92 gets progressively larger until the awning 14 is in the retracted position (e.g., until the third and fourth lateral supports 24c, 24d are parallel to each other).

As illustrated in the example embodiments of FIGS. 4A-4C, one or more mirrored second translational and rotational joints 23a of the lower longitudinal rod 30 are substantially the same as the second translational and rotational joints 23 of the lower longitudinal rod 28, except that the mirrored second translational and rotational joints 23a are mirror images of the second translational and rotational joints 23, and move in mirror image motions during extension and retraction of the awning 14. In this example embodiment, the third and fourth lateral supports 24c, 24d, coupled to one or more mirrored second translational and rotational joints 23a, move away from each other along arrows 76a, 76b when the glide 64 moves along direction 70b, and move toward each other along arrows 78a, 78b when the glide moves along direction 70a.

The lateral supports 24 comprise a pivotal connection 26 with the central longitudinal pivot rod 22. The central longitudinal pivot rod 22 in the illustrated example embodiment provides any combination of power, lighting, speaker sound, fans, insect repellant, and/or movie screen to the room 18 formed by the arcuate shape of the awning.

Illustrated in the example embodiments of FIGS. 4D-4F, is the pivot connection 26 including a rotational joint 27 of the central longitudinal pivot rod 22. In this embodiment, the rotational joint 27 couples the second and third lateral supports 24b, 24c to the central longitudinal pivot rod 22. As illustrated in FIGS. 4D, 4E, the second lateral support 24b couples the central longitudinal pivot rod 22 to the upper longitudinal rod 28, and the third lateral support 24c couples the central longitudinal pivot rod 22 to the lower longitudinal rod 30.

In one example embodiment, the central longitudinal pivot rod 22 has first and second end caps 66a, 66b spaced from each other longitudinally by the central longitudinal pivot rod 22. In this example embodiment, the first and second end caps 66a, 66b house the rotational joint 27. In another example embodiment, the rotational joint 27 is comprised within the central longitudinal pivot rod 22. In one example embodiment, the rotational joint 27 comprises an elbow or hinge joint 84 coupling the second lateral support 24b to the third lateral support 24c. The hinge joint 84 supports movement of the second and third lateral supports 24b, 24c toward each other along the direction indicated by arrows 72a, 72b responsive to the awning 14 moving into a retracted position, and away from each other along the direction indicated by arrows 73a, 73b responsive to the awning moving into the extended position. The hinge joint 84 supports the second and third lateral supports 24b, 24c during extension at an expanding angle 88 (see FIG. 4E). In one example embodiment, the expanding angle 88 is between 130° to about 170°. As the awning 14 extends, the second and third lateral supports 24b, 24c move away from each other along the direction indicated by arrows 73a, 73b and the expanding angle 88 is increased. As the awning 14 retracts, the second and third lateral supports 24b, 24c move toward each other, until they are parallel to each other, along the direction indicated by arrows 72a, 72b and the expanding angle 88 is decreased. In another example embodiment, as the awning 14 retracts, the second and third lateral supports 24b, 24c move toward each other along the direction indicated by arrows 72a, 72b and the expanding angle 88 is increased until the second and third lateral supports 24b, 24c are substantially parallel to each other, and reside in line with or underneath the central longitudinal pivot rod 22, such as when the awning 14 is fully retracted and residing within the awning casing 16. (see FIG. 4D1-4D2).

As illustrated in the example embodiment of FIG. 4F, the hinge joint 84 is coupled to an elbow pin 86 coupled to a rotating elbow joint 74. The rotating elbow joint 74 is housed within a complementary elbow housing 86. The rotating elbow joint 74 rotates along rotational directions 88a and 88b within the complementary elbow housing 86 during extension and retraction of the awning 14. In this example embodiment, the elbow pin 86 allows for rotation as the rotating elbow joint 74 opens and closes. In one example embodiment, the rotating elbow joint 74 is substantially cylindrical allowing for rotation about the longitudinal LONG axis within the complementary elbow housing 86. The complementary elbow housing 86 defines a complementary shape to the rotating elbow joint 74.

As illustrated in the example embodiments of FIG. 4D, one or more mirrored rotational joints 27 are substantially the same as the rotational joints 27, except that the mirrored rotational joints 27a are mirror images of the rotational joints 27, and move in mirror image motions during extension and retraction of the awning 14.

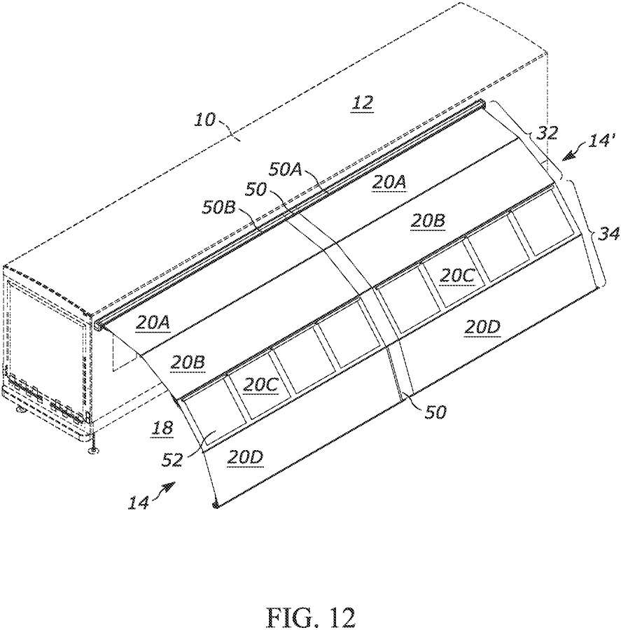

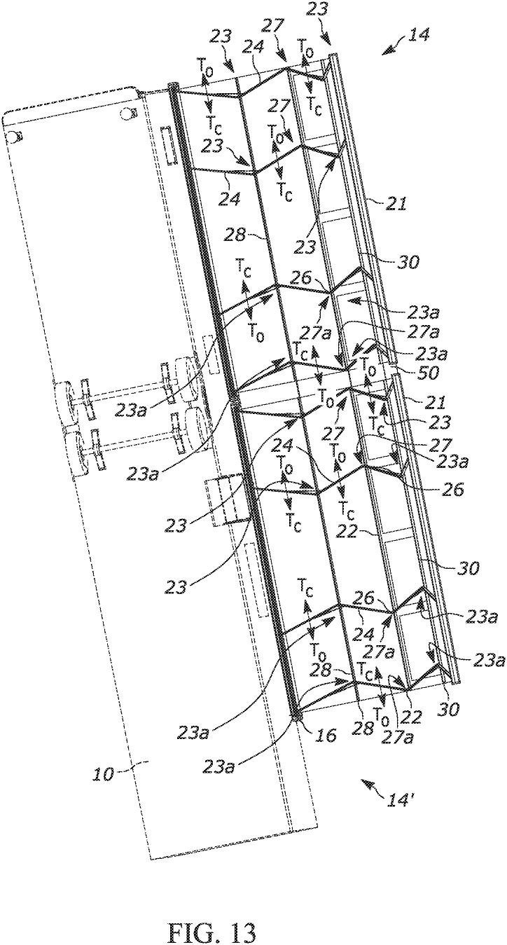

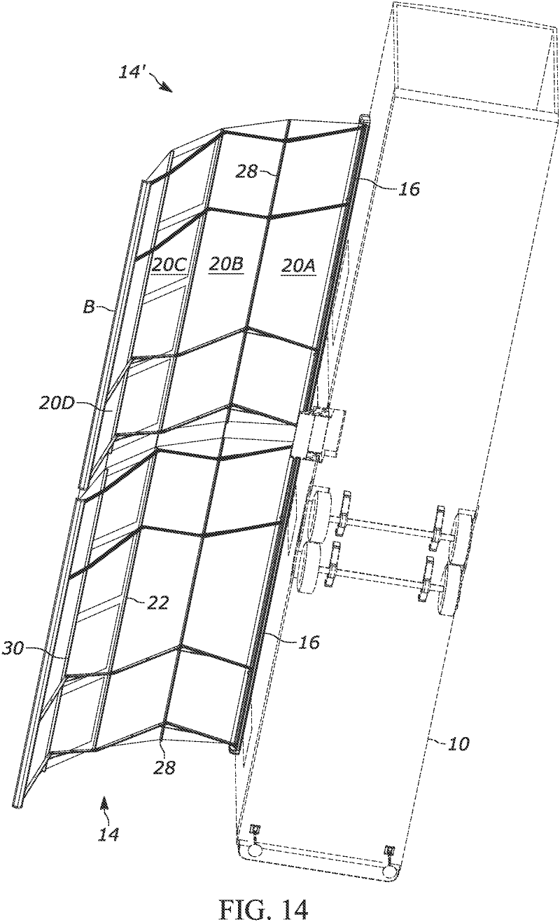

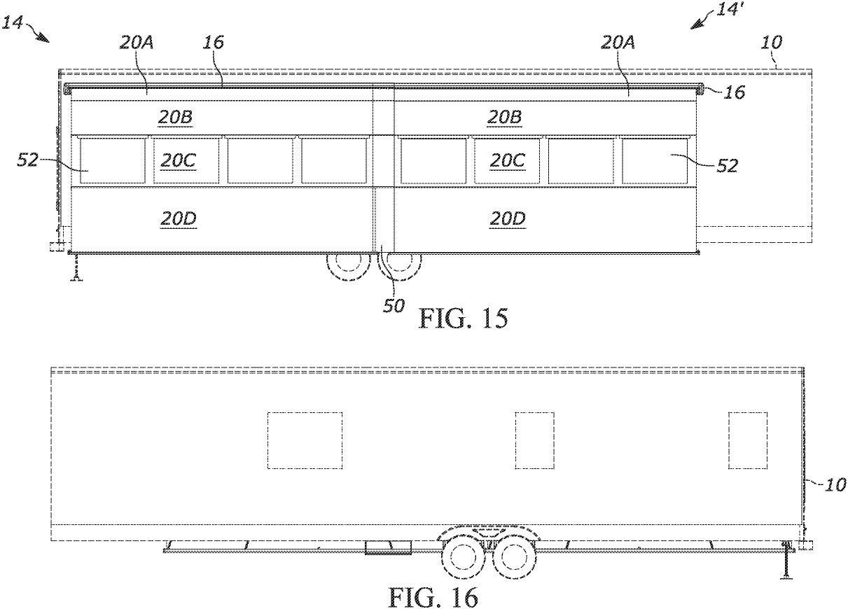

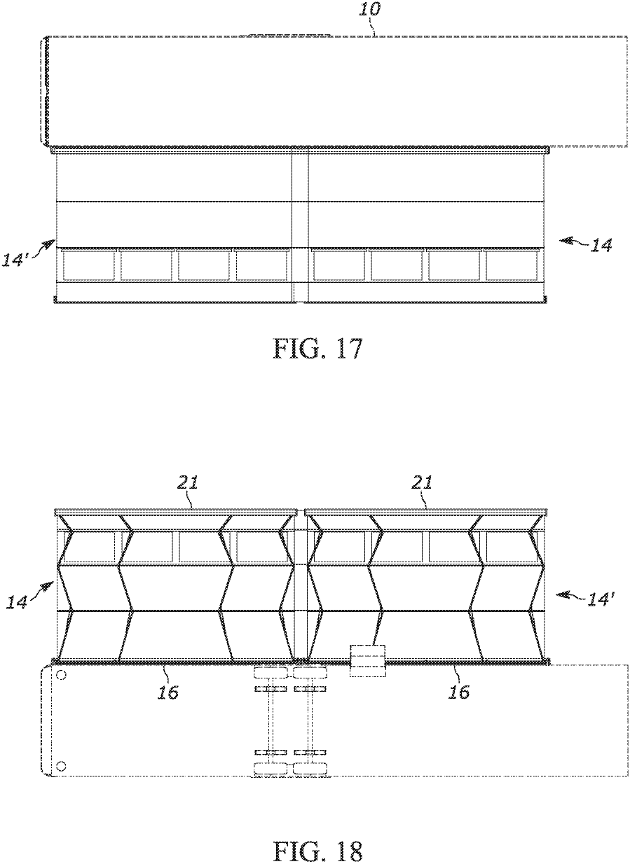

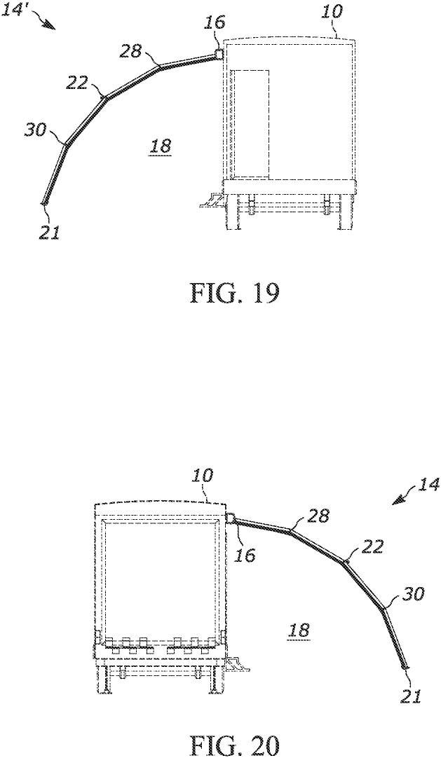

FIGS. 11A and 12-20 illustrate a retractable awning and room combination 14 in an extended condition in accordance with a second embodiment of the present disclosure. Features of FIGS. 11A and 12-20 are the same as in FIGS. 1-10 unless stated otherwise. In the illustrated example embodiment, the structure 10 is a camper 12, but could equally be a motorhome, building, or house without departing from the spirit and scope of the claimed disclosure. FIG. 11B illustrates the retractable awning 14 and room combination in a collapsed or closed position all the structures being located within the awning casing 16.

In yet a further example embodiment, the present disclosure includes an awning and room combination 14 contained during storage entirely within an awning casing 16. The awning forms an arcuate shape 18 in an extended position by a plurality of panels 20, two panels forming an upper panel section 32 and two panels forming a lower panel section 34. Coupling the upper section 32 with the lower section 34 is a central longitudinal pivot rod 22. The upper panel section 32 comprises an upper longitudinal sliding rod 28 and the lower panel section 34 comprises a lower longitudinal sliding rod 30. The central longitudinal pivot rod 22 is spaced from said longitudinal sliding rods 28, 30 by a plurality of lateral supports 24 that both translate and rotate about said upper and lower longitudinal sliding rods 28, 30 when extending and collapsing said awning as illustrated by arrows Tc in a closing position and To in an opening position. The lateral supports 24 rotating and sliding along longitudinal rods 28, 30, while solely pivoting about the pivot rod 22 at pivot points 26. That is, the lateral supports comprise a pivotal connection 26 with the central longitudinal pivot rod 22.

In the illustrated example embodiment of FIGS. 11A and 12-20 two retractable awnings 14 and 14′ are illustrated to provide a larger room than what is illustrated in the first embodiment. The operation of the awnings 14 and 14′ are the same, however, an attachment canopy 50 ties the two awnings 14 and 14′ panels together by snaps, ties, Velcro, or the like. Awning 14′ is substantially the same as awning 14 as discussed above with regard to FIGS. 1-10.

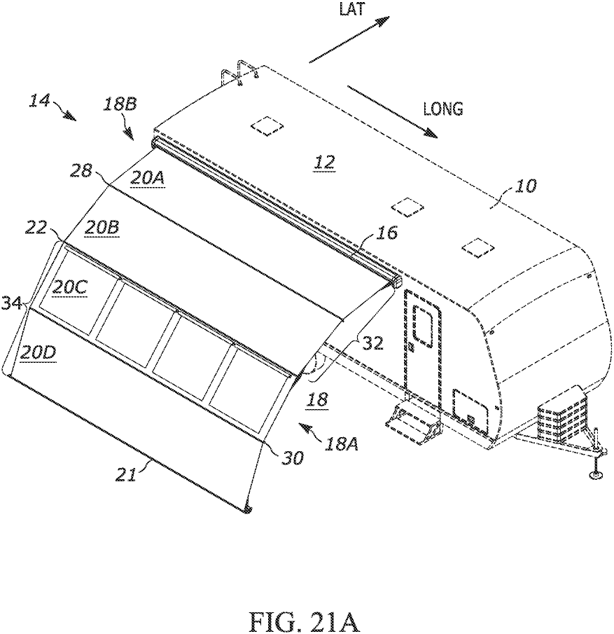

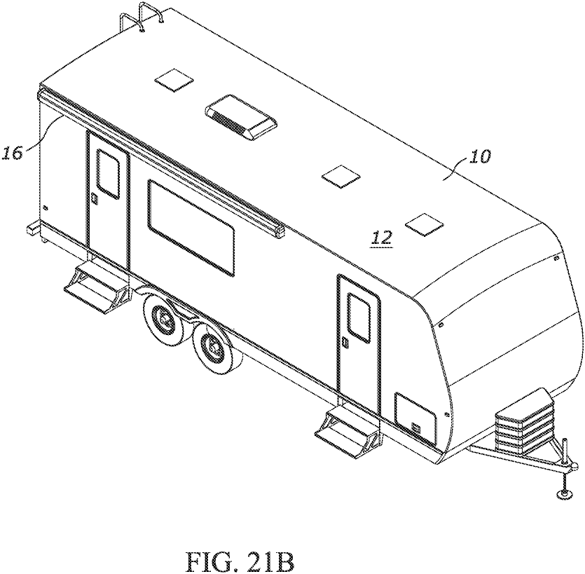

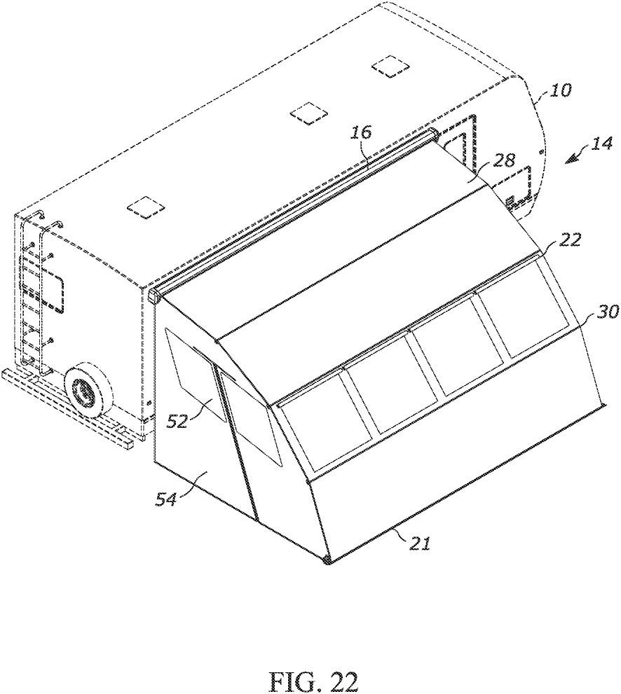

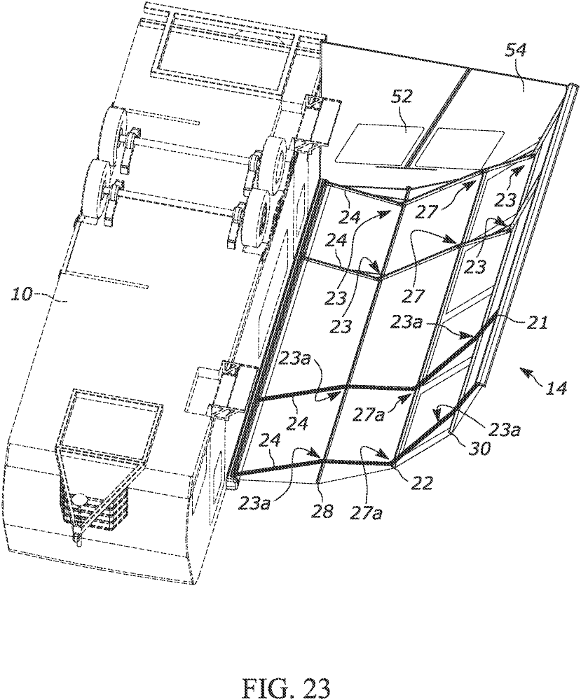

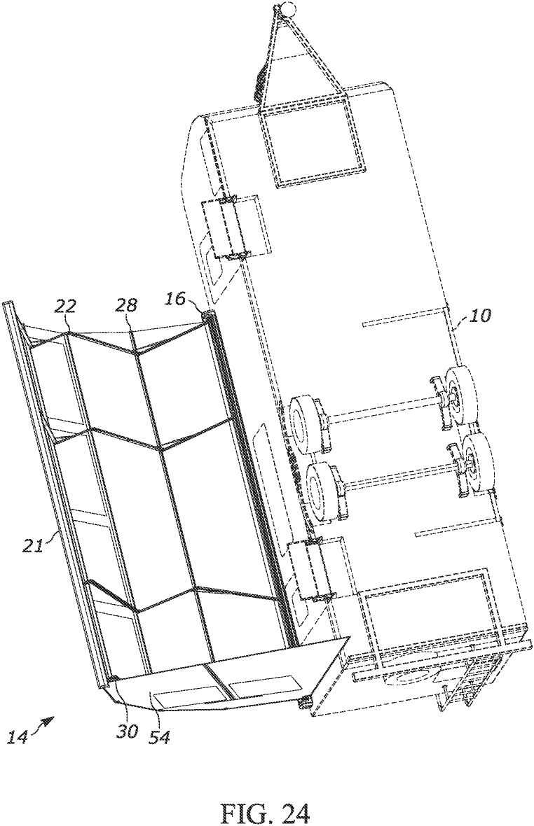

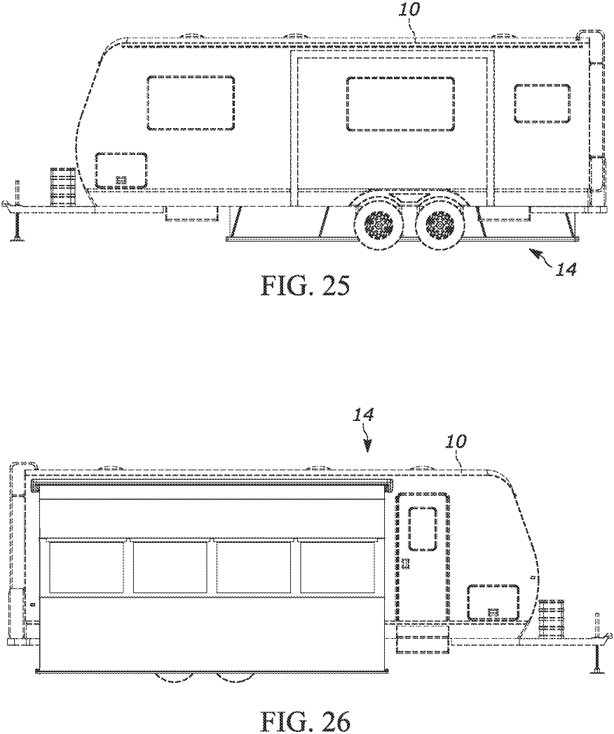

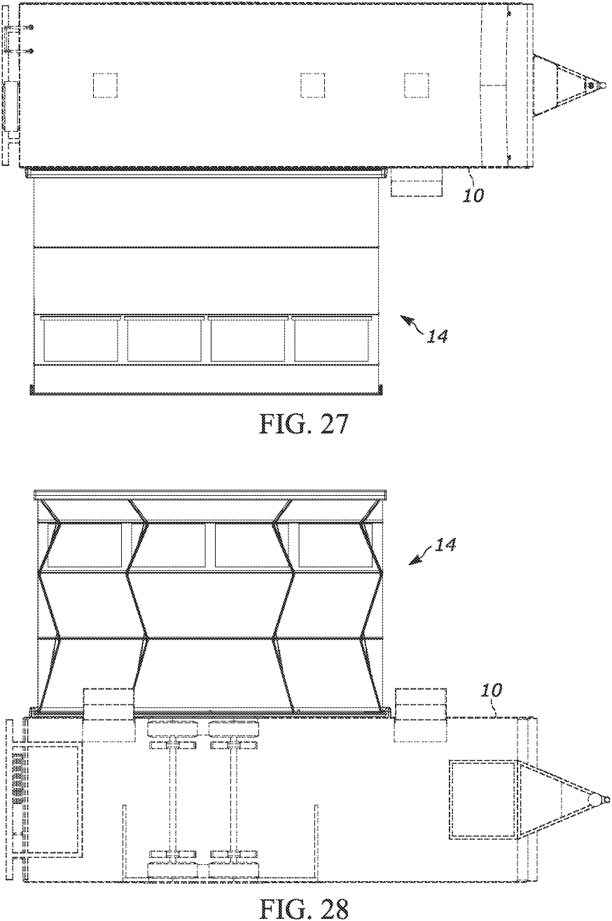

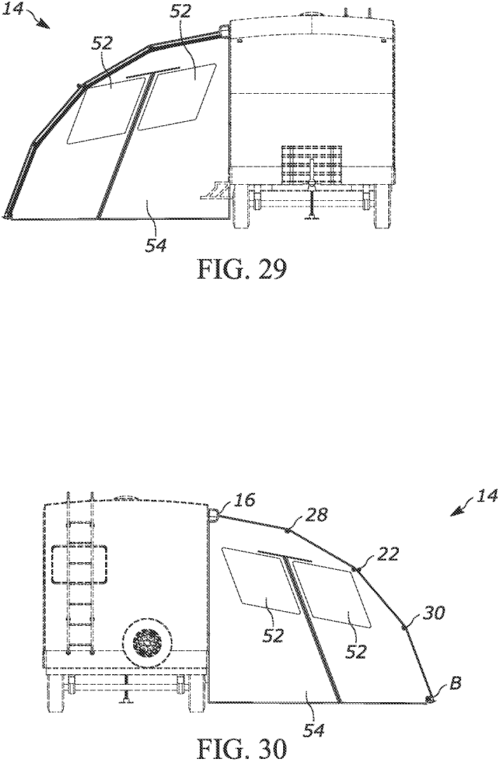

FIGS. 21A and 22-30 illustrate a retractable awning 14 and room combination in an extended condition in accordance with a third embodiment of the present disclosure. Features of FIGS. 21A and 22-30 are the same as in FIGS. 1-10 unless stated otherwise. In the illustrated example embodiment, the structure 10 is a camper 12, but could equally be a motorhome, building, or house without departing from the spirit and scope of the claimed disclosure. FIG. 21B illustrates the retractable awning 14 and room combination in a collapsed or closed position all the structures being located within the awning casing 16.

While in this example embodiment of the present disclosure includes an awning 14 contained during storage entirely within an awning casing 16. The awning forms an arcuate shape 18 in an extended position by a plurality of panels 20, two panels 32 forming an upper panel section and two panels 34 forming a lower panel section. Coupling the upper section 32 with the lower section 34 is a central longitudinal pivot rod 22. The upper panel section 32 comprises an upper longitudinal sliding rod 28 and the lower panel section 34 comprises a lower longitudinal sliding rod 30. The central longitudinal pivot rod 22 is spaced from said longitudinal sliding rods 28, 30 by a plurality of lateral supports 24 that both translate and rotate about said upper and lower longitudinal sliding rods 28, 30 when extending and collapsing said awning 14. The lateral supports 24 comprise a pivotal connection 26 with the central longitudinal pivot rod 22.

The arcuate shape 18 formed by the awning forms first and second ends 18A and 18B spaced longitudinally from each other. The awning 14 further comprising a planar side 54 for enclosing at least one or both of said first 18A and second ends 18B. The operation of the awning 14 is the same, however, as in the first and second embodiments disclosed above. In this example embodiment, the planar side 54 is attached after the awning is extended. The planar side is attached to the panels 20 by snaps, ties, bungie cords, Velcro, or the like. In one example embodiment, the side panel 54 includes windows 52.

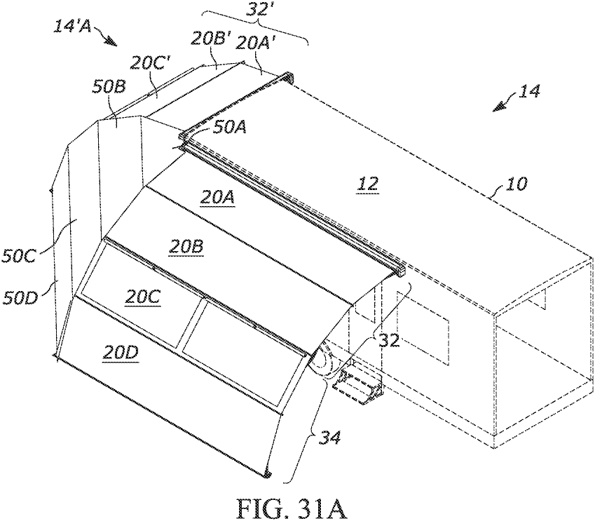

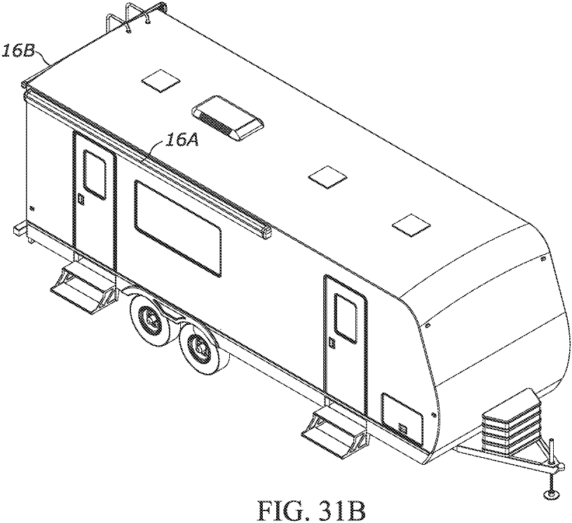

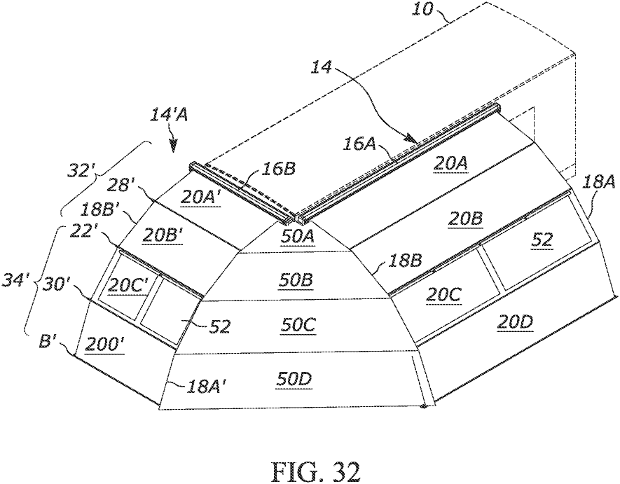

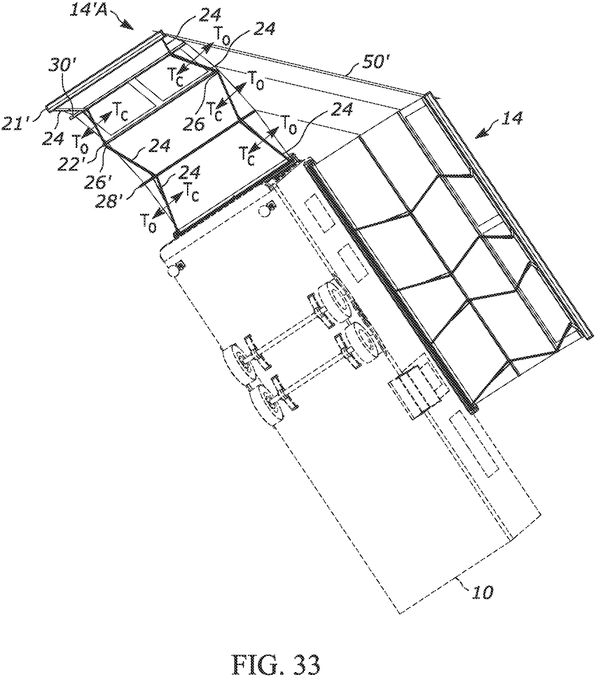

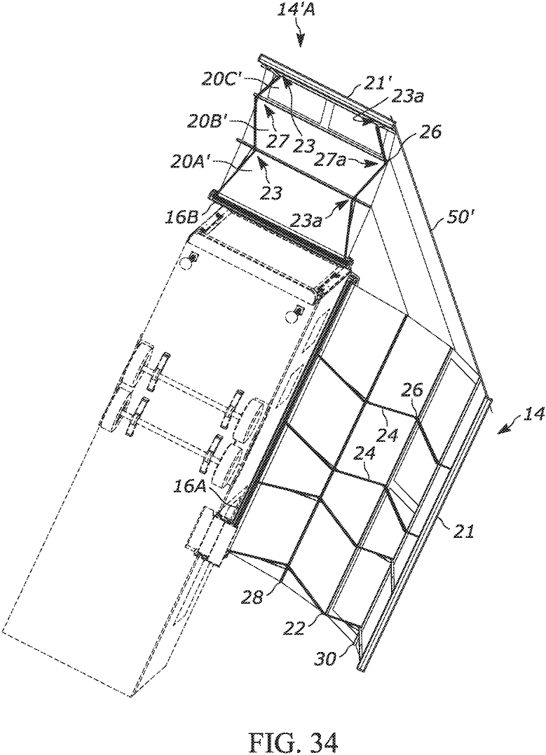

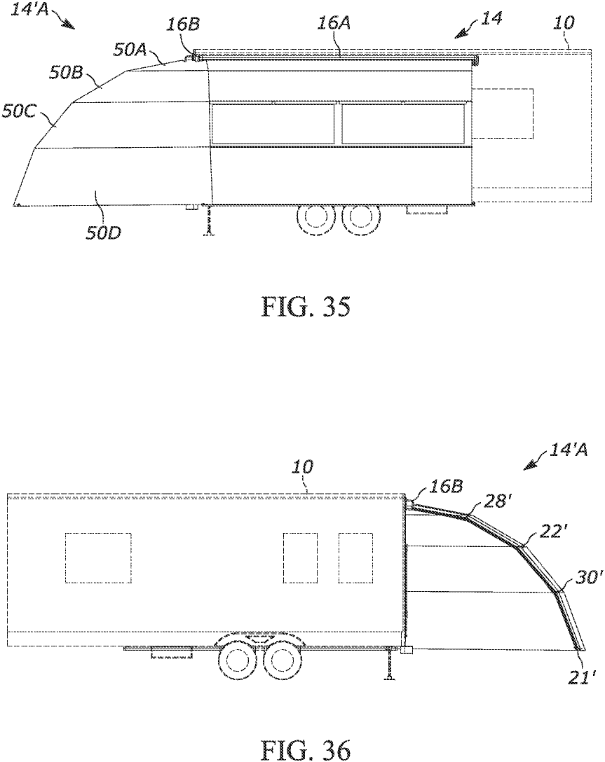

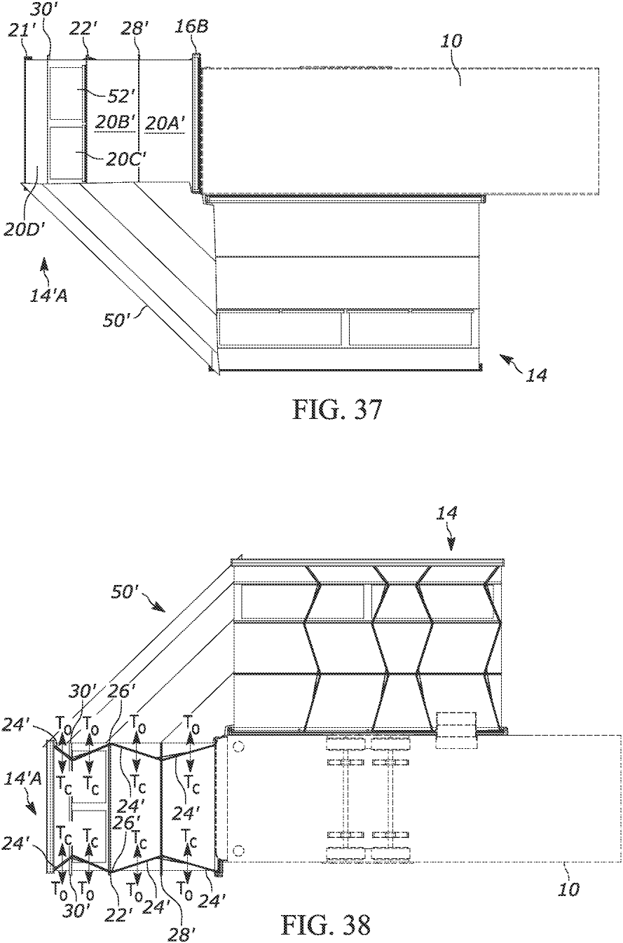

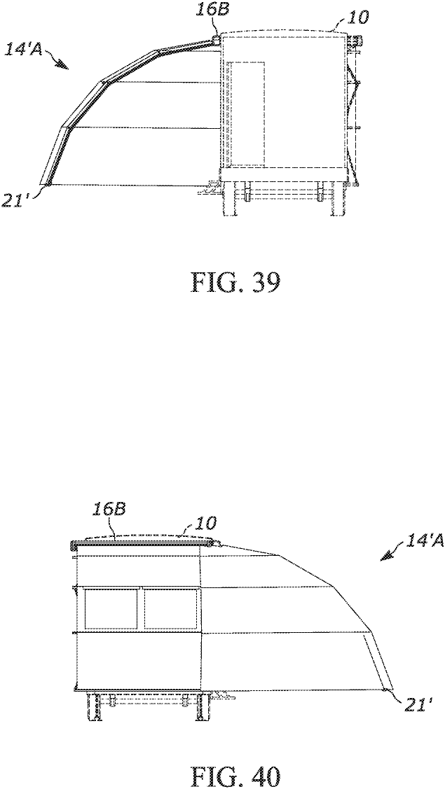

FIGS. 31A and 32-40 illustrate a retractable awning and room combinations 14 and 14′a in an extended condition in accordance with a fourth embodiment of the present disclosure. Features of FIGS. 31A and 32-40 are the same as in FIGS. 1-10 unless stated otherwise. In the illustrated example embodiment, the structure 10 is a camper 12, but could equally be a motorhome, building, or house without departing from the spirit and scope of the claimed disclosure. FIG. 31B illustrates the retractable awnings 14 and 14′a and room combination collapsed or closed positions, all the structures being located within the awning casings 16. Awning 14′a functions in a substantially same manner as awning 14 as discussed above with regard to FIGS. 1-10.

The present embodiment includes first and second awnings 14, 14′a contained during storage entirely within first and second awning casings 16A and 16B. The awnings 14, 14′a form arcuate shapes 18a, 18b in an extended position by a plurality of panels 20 and 20′. Two panels forming an upper panel section 32 and 32′ and two panels form a lower panel section 34 and 34′. Coupling the upper sections 32, 32′ with the lower sections 34, 34′ are central longitudinal pivot rods 22, 22′. The upper panel sections 32, 32′ comprise an upper longitudinal sliding rod 28, 28′ and the lower panel sections 34, 34′ comprise a lower longitudinal sliding rod 30, 30′. The central longitudinal pivot rod 22, 22′ is spaced from said longitudinal sliding rods 28, 28′, 30, 30′ by a plurality of lateral supports 24, 24′ that both translate and rotate about said upper and lower longitudinal sliding rods when extending and collapsing said awnings 14, 14′a. The lateral supports comprise a pivotal connection 26, 26′ with the central longitudinal pivot rod and operate in the same fashion as the prior embodiments.

The arcuate shape 18 formed by the awnings 14, 14′a forms first end 18A′ and second end 18B that are connected by a panel 50 having a plurality of sections 50A-50D for enclosing both said first end 18A′ and second end 18B. The operation of the awnings 14 and 14′a are the same as described above with regard to the first and second embodiments. In this example embodiment, the panel 50 is attached after the awnings 14, 14′a are is extended. The panels 20 and 20′ are connected to the awnings 14, 14′a by snaps, ties, bungie cords, Velcro, or any combination thereof.

During operation, the awning 14 is extended responsive to user actuating a crank or actuating an extend/retract actuator. Responsive to a duration of actuation, a programed response to actuation, and/or speed of cranking, the awning 14 is partially and fully extended. During extension, the lead rail 21 is extended concurrently along the lateral LAT and horizontal HOR directions toward the ground and away from the structure 10. During extension, the first and second supports 24a, 24b are extended first, while the third and fourth supports 24c, 24d remain retracted until the first and second supports 24a, 24b are fully extended. Once the first and second supports 24a, 24b are fully extended, the third and fourth supports 24c, 24d are extended. The roll bar 17, in conjunction with the lead rail 21, maintains tension on the canopy 15 during the extension. The extension of the first and second supports 24a, 24b or upper panel section 32 prior to the extension of the third and fourth supports 24c, 24d or lower panel section 34, allows for the partial extension of the awning 14 while maintaining the arcuate shape of the awning 14 during the partial extension. Further, the extension of the third and fourth supports 24c, 24d or lower panel section 34 after full extension of the first and second supports 24a, 24b or upper panel section 32 allows for variable extension of the awning 14 having the arcuate shape to address different ground heights.

Responsive to user actuating or cranking the awning 14 to retract said awning, the awning is retracted. Responsive to a duration of actuation, a programed response to actuation, and/or speed of cranking to retract the awning 14, the awning 14 is fully or partially retracted. During retraction, the lead rail 21 is retracted concurrently along the lateral LAT and horizontal HOR directions toward the structure 10 and away from the ground. During retraction, the third and fourth supports 24c, 24d are retracted first, while the first and second supports 24a, 24b remain extended until the third and fourth supports 24c, 24d are fully retracted. Once the third and fourth supports 24c, 24d are fully retracted, the first and second supports 24a, 24b are retracted. The roll bar 17 in conjunction with the lead rail 21 maintains tension on the canopy 15 during the retraction. The retraction of the third and fourth supports 24c, 24d or lower panel section 34 prior to the retraction of the first and second supports 24a, 24b or upper panel section 32, allows for the partial retraction of the awning 14 while maintaining the arcuate shape of the awning 14 during the partial retraction.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ... a”, “has ... a”, “includes ... a”, “contains ... a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact either temporarily or permanently, although not necessarily directly and not necessarily mechanically. A device or structure that is “configured” in a certain way is configured in at least that way, but may also be configured in ways that are not listed. The term “integral” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiments, e.g., E₁, E₂, ...Eₙ and that each embodiment E may have multiple parts A₁, B₁, C₁....Zₙ that (without further description) could be combined with other embodiments Eₙ, embodiment parts e.g. A₁, C₁, or lack of parts originally associated with one or all embodiments Eₙ, or any combination of parts and/or embodiments thereof. It should further be appreciated that an embodiment Eₙ may include only one part e.g. A₁ or a lesser number of parts e.g. B₁, C₁ of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes after having the benefit of reviewing the subject disclosure and accompanying drawings.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. (canceled)

2. An awning extending from an awning casing, the awning forming an arcuate shape, the awning comprising:
an awning casing that is couplable to a surface, the awning casing coupled to a first end of a canopy, the awning casing extending along a longitudinal axis, the awning casing coupled to a first lateral support;
a first translational and rotational joint coupling the first lateral support and a second lateral support to an upper longitudinal pivot rod, the upper longitudinal pivot rod extending along the longitudinal axis, the first and second lateral supports extending along lateral and horizontal directions when the awning is in an extended position, the translational and rotational joint translating along the longitudinal axis during extension and retraction of the awning along the lateral and horizontal directions; and
a rotational joint coupling the second lateral support and a third lateral support to a central longitudinal pivot rod, the central longitudinal pivot rod extending along the longitudinal axis, the second and third lateral supports extending along the lateral and horizontal directions when the awning is in the extended position, the rotational joint rotating during extension and retraction of the awning.

3. The awning of claim 2, further comprising a second translational and rotational joint coupling the third lateral support and a fourth lateral support to a lower longitudinal pivot rod, the second translational and rotational joint rotating and translating along the longitudinal axis during extension and retraction of the awning along the lateral and horizontal directions.

4. The awning of claim 3, further comprising a lead rail to the fourth lateral support, the lead rail housing a roll bar coupled to a second end of the canopy.

5. The awning of claim 2, wherein the awning is contained when fully retracted entirely within the awning casing, the awning causing housing a roll bar coupled to the first end of the canopy.

6. The awning of claim 2, the first translational and rotational joint comprises a rotating joint coupling the first lateral support to the second lateral support, the rotating joint is rotationally coupled to a pin and glide, the glide slidably coupled to the upper longitudinal pivot rod.

7. The awning of claim 6, the pin rotating relative to the rotating joint and the glide.

8. The awning of claim 6, the upper longitudinal pivot rod defining a track that extends longitudinally along at least a portion of the upper longitudinal pivot rod, the glide movably housed within the track.

9. The awning of claim 8, the glide moving toward a center line of the awning during retraction of the awning, and away from the center line of the awning during extension of the awning.

10. The awning of claim 2, the central longitudinal pivot rod supporting first and second end caps, the first end cap comprising a portion of the rotational joint.

11. The awning of claim 2, the rotational joint comprising a hinge joint coupling the second lateral support to third lateral support, the hinge joint coupled to an elbow pin and rotating elbow joint housed within a complementary elbow housing.

12. The awning of claim 11, wherein the elbow pin is partially housed within the central longitudinal pivot rod and the rotating elbow joint and the complementary elbow housing housed within the central longitudinal pivot rod.

13. The awning of claim 11, wherein the rotating elbow joint rotates relative to the complementary elbow housing.

14. The awning of claim 2, wherein the first translational and rotational joint is opposite a first mirrored translational and rotational joint across the upper longitudinal pivot rod, the first mirrored translational and rotational joint translating along the longitudinal axis in a first direction during extension and retraction of the awning, and the first translational and rotational joint translating along the longitudinal axis during extension and retraction of the awning along a second direction, the first direction opposite the second direction.

15. The awning of claim 2, wherein the rotational joint is opposite a mirrored rotational joint across the central longitudinal pivot rod, the rotational joint coupled to a first end of the central longitudinal pivot rod and the mirrored rotational joint coupled to a second end of the central longitudinal pivot rod, the first end opposite the second end, the rotational joint comprising a mirror image of the mirrored rotational joint, wherein the rotational joint and mirrored rotational joint move in concert during extension and retraction of the awning along the lateral and horizontal directions.

16. The awning of claim 2, responsive to the awning being retracted, the first, second and third lateral supports are substantially parallel to each other, and to the upper and central longitudinal pivot rods.

17. The awning of claim 2, wherein the first, second, and third lateral supports extend along the longitudinal axis when the awning is in a retracted position.

18. The awning of claim 2, responsive to being in the extended position, an upper angle between the first and second lateral supports is less than 170°, and a central angle between the second and third lateral supports is less than 170° forming the canopy into an arced surface.

19. An awning extending from an awning casing, the awning forming an arcuate shape, the awning comprising:
an awning casing that is couplable to a surface, the awning casing supporting a roll bar coupled to a first end of a canopy, the awning casing and the roll bar extending along a longitudinal axis, the awning casing coupled to a first lateral support;
a first translational and rotational joint coupling the first lateral support and a second lateral support to an upper longitudinal pivot rod, the upper longitudinal pivot rod extending along the longitudinal axis, the first and second lateral supports extending along lateral and horizontal directions when the awning is in an extended position, the translational and rotational joint translating along the longitudinal axis during extension and retraction of the awning along the lateral and horizontal directions;
a rotational joint coupling the second lateral support and a third lateral support to a central longitudinal pivot rod, the central longitudinal pivot rod extending along the longitudinal axis, the second and third lateral supports extending along the lateral and horizontal directions when the awning is in the extended position, the rotational joint rotating during extension and retraction of the awning;
a second translational and rotational joint coupling the third lateral support and a fourth lateral support to a lower longitudinal pivot rod, the second translational and rotational joint translating along the longitudinal axis during extension and retraction of the awning along the lateral and horizontal directions; and
a lead rail coupled to a second end of the canopy, the lead rail coupled to the fourth lateral support rod, the canopy extending between the awning casing and the lead rail in the extended position, the canopy interacting with the upper, center, and lower longitudinal support rods to form an arced surface, when fully extended the lead rail is extended laterally and horizontally away from the awning casing.

20. The awning of claim 19, the first translational and rotational joint comprises a rotating joint coupling the first lateral support to the second lateral support, the rotating joint is rotationally coupled to a pin and glide, the glide slidably coupled to the upper longitudinal pivot rod via a track that extends longitudinally along at least a portion of the upper longitudinal pivot rod, the glide movably housed within the track.

21. (canceled)

22. A method of utilizing an awning casing that is couplable to a surface, the awning forming an arcuate shape, the method comprising the steps of:
supplying the awning casing supporting a roll bar coupled to a first end of a canopy, the awning casing and the roll bar extending along a longitudinal axis;
coupling the awning casing to a first lateral support;
coupling the first lateral support to a second lateral support and coupling both to an upper longitudinal pivot rod via a first translational and rotational joint, the upper longitudinal pivot rod extending along the longitudinal axis, the first and second lateral supports extending along lateral and horizontal directions when the awning is in an extended position, the translational and rotational joint translating along the longitudinal axis during extension and retraction of the awning along the lateral and horizontal directions;
coupling the second lateral support to a third lateral support and coupling both to a central longitudinal pivot rod via a rotational joint, the central longitudinal pivot rod extending along the longitudinal axis, the second and third lateral supports extending along the lateral and horizontal directions when the awning is in the extended position, the rotational joint rotating during extension and retraction of the awning;
coupling the third lateral support to a fourth lateral support and coupling both to a lower longitudinal pivot rod via a second translational and rotational joint, the second translational and rotational joint translating along the longitudinal axis during extension and retraction of the awning along the lateral and horizontal directions; and
coupling a lead rail to a second end of the canopy, and coupling the lead rail to the fourth lateral support rod, the canopy extending between the awning casing and the lead rail in the extended position, the canopy interacting with the upper, center, and lower longitudinal support rods to form an arced surface, when fully extended the lead rail is extended laterally and horizontally away from the awning casing.

23. (canceled)
